(19) United States
(12) Patent Application Publication
(10) Pub. No.: US 2012/0255758 A1
(43) Pub. Date: Oct. 11, 2012

(54) Extension Hose for Vacuum Cleaners

(76) Inventor: Hyun Mi LEE, Busan (KR)

(21) Appl. No.: 13/081,997

(22) Filed: Apr. 7, 2011

(51) Int. Cl. F16L 11/127

(52) U.S. Cl. 174/47

(57) ABSTRACT

The present invention relates to an extension hose for a vacuum cleaner, which includes a female connector mounted at one end thereof and a male connector mounted at other end thereof so that a flexible hose of the vacuum cleaner can be extended, thereby improving a convenience in use.

### BACKGROUND OF THE INVENTION

1. Field of the Invention

The present invention relates to an extension hose for a vacuum cleaner, and more particularly, to such an extension hose for a vacuum cleaner, which includes a female connector mounted at one end thereof and a male connector mounted at other end thereof so that a flexible hose of the vacuum cleaner can be extended.

2. Background of the Related Art

In general, a centralized vacuum cleaning system is installed in apartments, offices, hospitals, hotels, and the like to implement a suction structure in which a strong suction force is applied to each unit compartment, and dust particles and foreign substances present on the surface of a floor are forcibly sucked into the each unit compartment using the suction force so as to be sent to a central dust collector, thereby providing a cleaner living environment to people.

FIG. 1 is a view illustrating a centralized vacuum cleaning system, and FIG. 2 is a perspective view illustrating an inlet value mounted at a wall so as to be connected with a centralized vacuum cleaning system.

As shown in FIGS. 1 and 2, the centralized vacuum cleaning system is constructed such that a central dust collector 1 is installed at a part of a building and a suction pipe 2 is installed to extend to each unit compartment to allow a suction force generated from the central dust collector 1 upon application of a power to be applied to each unit compartment (indoor). In this case, the suction pipe 2 is connected at one end thereof to the inlet valve 3 installed at a wall of a building.

In addition, a male connector 4a mounted at one end of a flexible hose 4 is fixedly fitted into the inlet valve 3 installed at the building wall so that the generated suction force can be transferred to even a vacuum cleaner 5 connected to the other end of the flexible hose 4 to clean the floor surface of each unit compartment. That is, since the flexible hose 4 includes an electric wire embedded therein, the power can be applied to the central vacuum cleaning system by the fitting connection of the flexible hose 4 to the inlet valve installed at the wall to cause the suction force generated from the central dust collector 1 to be transferred to the vacuum cleaner 5 to perform a vacuum cleaning function. Herein, the vacuum cleaner 5 includes a brush nozzle 5a, an air pipe 5b, and a handle 5c. The flexible hose 4 is mounted at the handle 5c in such a fashion as to fluidically communicate with the handle 5c.

Such a flexible hose 4, however, entails a drawback in that since it is limited in its length, the vacuum cleaning function cannot be performed in a range apart away more than a predetermined distance. In other words, since the vacuum cleaning operation can be carried out only in a range corresponding to the length of the flexible hose 4, it is impossible to perform the vacuum cleaning operation in a range exceeding the length of the flexible hose 4.

### SUMMARY OF THE INVENTION

Accordingly, the present invention has been made in order to solve the above-described problems occurring in the prior art, and it is an object of the present invention to provide an extension hose for a vacuum cleaner, which includes a female connector mounted at one end thereof and a male connector mounted at other end thereof so that a flexible hose of the vacuum cleaner can be extended, thereby improving a convenience in use.

To achieve the above object, the present invention provides an extension hose for a vacuum cleaner, which is adapted to allow a flexible hose to be extended, the flexible hose having one end to which the vacuum cleaner including a brush nozzle is connected and the other end at which a male connector is mounted so as to be fixedly fitted into an inlet valve installed at a wall of a building, the extension hose including; a hose body configured to have the same structure as that of the flexible hose so that the flexible hose can be extended, the hose body including an electric wire embedded therein; a female connector mounted at one end of the hose body in such a fashion as to be electrically connected with the electric wire embedded in the hose body to cause the female connector to be electrically connected with the male connector of the flexible hose, the female connector comprising a pair of ground terminals formed protrudingly on the inner circumferential surface thereof to have a predetermined tension through a ground spring so that the female connector is electrically contactingly connected with the male connector of the flexible hose; and a male connector 8 mounted at the other end of the hose body in such a fashion as to be electrically connected with the electric wire embedded in the hose body so as to be fitted into the inlet valve, the male connector comprising a pair of ground pieces formed exposedly on the outer circumferential surface thereof, the ground pieces serving as contact points so that the male connector can be electrically connected with the inlet valve.

In addition, the extension hose for a vacuum cleaner further includes a cover mounted at an opening formed at one end of the female connector to allow the opening of the female connector to be opened or closed by an elastic restoring force of a spring.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view illustrating a centralized vacuum cleaning system;

FIG. 2 is a perspective view illustrating an inlet value mounted at a wall so as to be connected with a centralized vacuum cleaning system.

FIG. 3 is a perspective view illustrating an extension hose for a vacuum cleaner according to the present invention;

FIG. 4 is a perspective view illustrating a female connector mounted at one end of an extension hose for a vacuum cleaner according to the present invention;

FIG. 5 is a cross-sectional view taken along the line I-I shown in FIG. 4;

FIG. 6 is a cross-sectional view taken along the line II-II shown in FIG. 5;

FIG. 7 is a perspective view illustrating a male connector mounted at the other end of an extension hose for a vacuum cleaner according to the present invention;

FIG. 8 is a cross-sectional view taken along the line III-III shown in FIG. 7;

FIG. 9 is a cross-sectional view taken along the line IV-IV shown in FIG. 8; and

FIG. 10 is a view illustrating a use example of an extension hose for a vacuum cleaner according to the present invention.

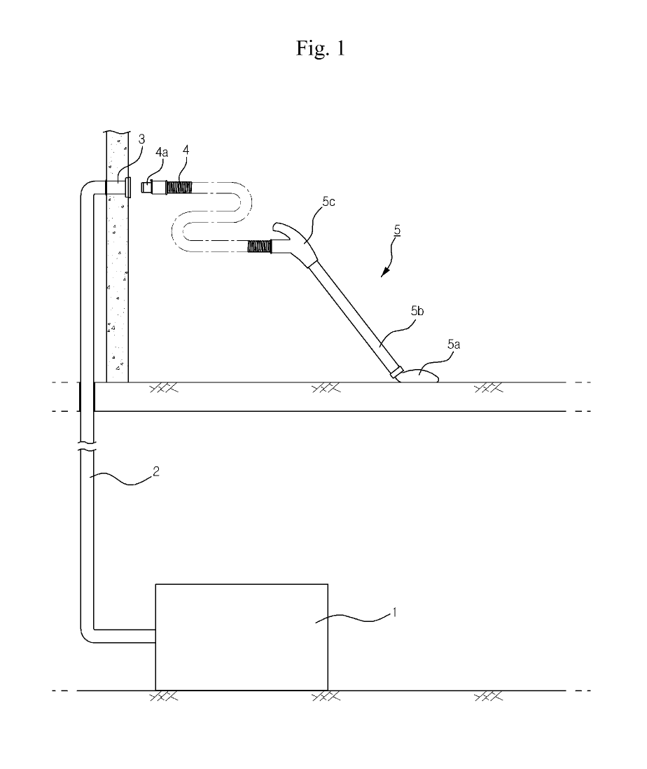

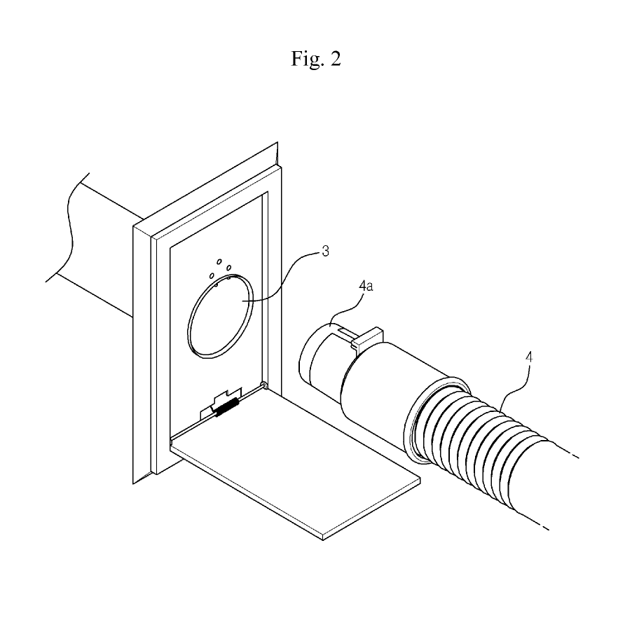

### DETAILED DESCRIPTION OF THE PREFERRED EMBODIMENTS

Now, a preferred embodiment of the present invention will be descried hereinafter in more detail with reference to the accompanying drawings.

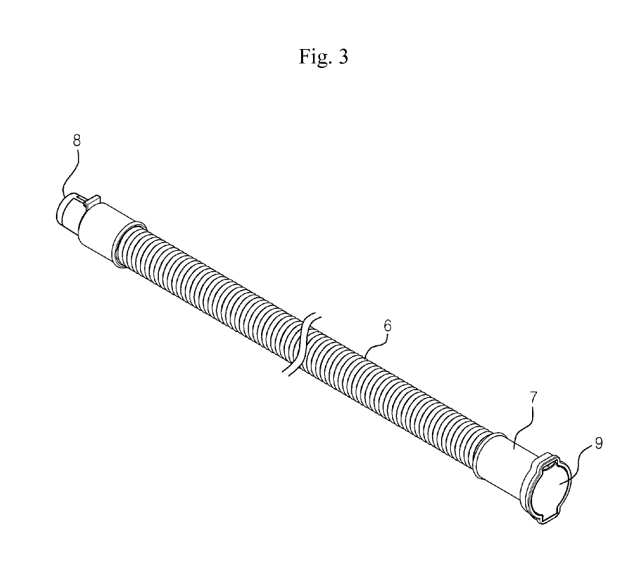

FIG. 3 is a perspective view illustrating an extension hose for a vacuum cleaner according to the present invention.

Referring to FIG. 3, there is shown an extension hose 6 for a vacuum cleaner. The extension hose 6 is a sort of flexible hose that includes an electric wire 6a embedded therein and is formed to have a certain length. The extension hose 6 includes a female connector 7 mounted at one end thereof and a male connector 8 mounted at the other end thereof.

The extension hose 6 enables a flexible hose 4 to be extended. That is, a vacuum cleaner 5 including a handle 5c, an air pipe 5b, and a brush nozzle 5a is connected to one end of the flexible hose 4 and a male connector 4a is mounted at the other end of the flexible hose 4 so as to be fixedly fitted into an inlet valve 3 installed at the building wall. The flexible hose 4 can be extended by means of the extension hose 6.

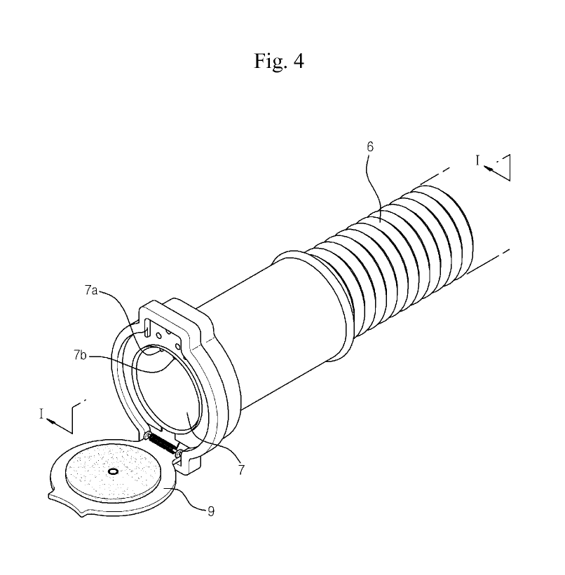

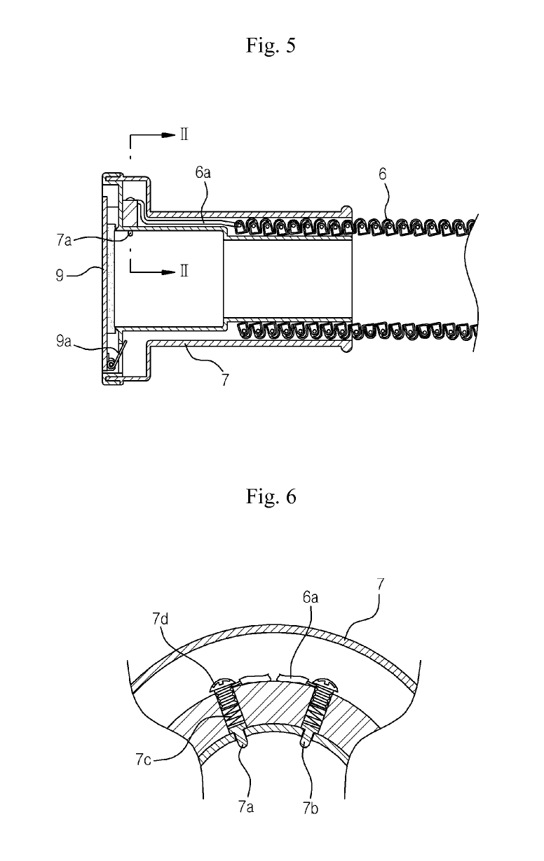

FIG. 4 is a perspective view illustrating a female connector mounted at one end of an extension hose for a vacuum cleaner according to the present invention, FIG. 5 is a cross-sectional view taken along the line I-I shown in FIG. 4, and FIG. 6 is a cross-sectional view taken along the line II-II shown in FIG. 5.

Referring to FIGS. 4 to 6, there is shown a female connector 7 mounted at one end of a hose body of the extension hose 6 for a vacuum cleaner according to the present invention. The female connector 7 is configured to allow the male connector 4a mounted at the other end of the flexible hose 4 to be fixedly fitted thereinto. The female connector 7 has a fitting hole defined therein and the extension hose 6 includes a cover 9 mounted at one end of the female connector 7 to allow the fitting hole of the female connector 7 to be opened or closed by an elastic restoring force of a spring 9a.

In addition, the female connector 7 includes a pair of ground terminals 7a and 7b formed protrudingly on the inner circumferential surface of the fitting hole thereof so that the ground terminals can be electrically connected with the electric wire 6a embedded in the extension hose 6. The two ground terminals 7a and 7b are installed to have a predetermined tension so that when the male connector 4a mounted at the other end of the flexible hose 4 is fitted into the female connector 7, the flexible hose 4 is electrically connected with the extension hose 6 through the ground terminals 7a and 7b.

As shown in FIG. 6, the female connector 7 includes a ground spring 7c mounted at one end of each of the two ground terminals 7a and 7b to have a predetermined tension, and a fastening screw 7d that supports the ground spring 7c. In addition, the electric wire 6a is fixedly connected to the fastening screw 7d so that the ground terminals 7a and 7b are electrically connected with the electric wire 6a through the ground spring 7c and the fastening screw 7d.

Thus, when the male connector 4a mounted at the other end of the flexible hose 4 is fitted into the fitting hole of the female connector 7 via the two ground terminals 7a and 7b, the ground terminals are electrically connected with a ground part mounted at the male connector 4a. That is, when the male connector 4a is fitted into the fitting hole, the ground part formed on the outer circumferential surface of the male connector 4a is electrically connected with the ground terminals 7a and 7b while contactingly pushing the ground terminals upwardly.

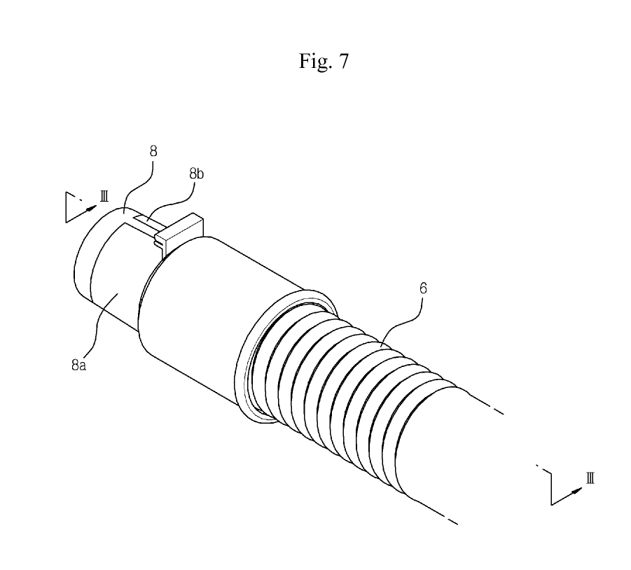

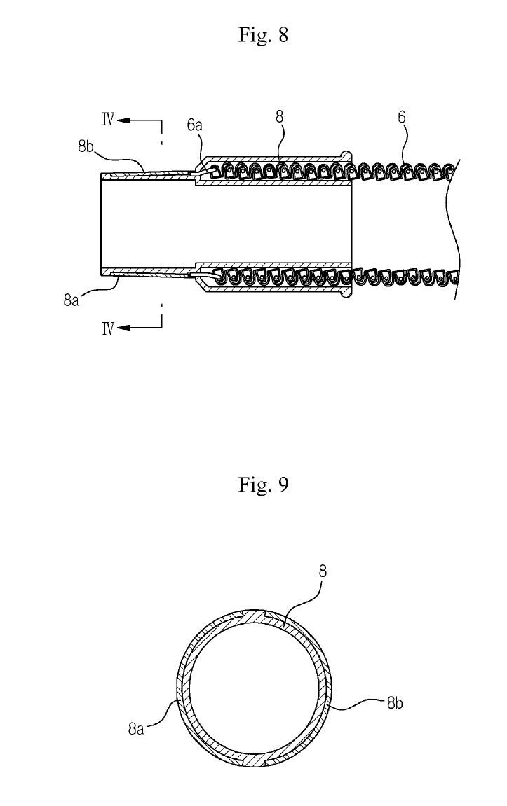

FIG. 7 is a perspective view illustrating a male connector mounted at the other end of an extension hose for a vacuum cleaner according to the present invention, FIG. 8 is a cross-sectional view taken along the line III-III shown in FIG. 7, and FIG. 9 is a cross-sectional view taken along the line IV-IV shown in FIG. 8.

Referring to FIGS. 7 to 9, there is shown a male connector 8 mounted at the other end of the extension hose 6 for a vacuum cleaner according to the present invention. The male connector 8 is configured to be fixedly fitted into the inlet valve 3 installed at the wall of a building. The male connector 8 also includes a pair of ground pieces 8a and 8b formed exposedly on the outer circumferential surface thereof so that the ground pieces can be electrically connected with the electric wire 6a embedded in the extension hose 6. The two ground pieces 8a and 8b are installed to be disposed at both sides of the outer circumferential surface thereof so that when the male connector 8 is fitted into the inlet valve 3, the extension hose 6 is electrically connected with the inlet valve 3 through the ground pieces 8a and 8b.

When the male connector 8 is fitted into the inlet valve installed at the building wall by means of the two ground pieces 8a and 8b, it is electrically connected with the ground part installed at the inlet valve 3. That is, when the male connector 8 is fitted into the inlet valve 3, the ground pieces 8a and 8b formed on the outer circumferential surface of the male connector 8 are electrically connected with the ground part of the inlet valve 3 while being brought into close contact with the ground part.

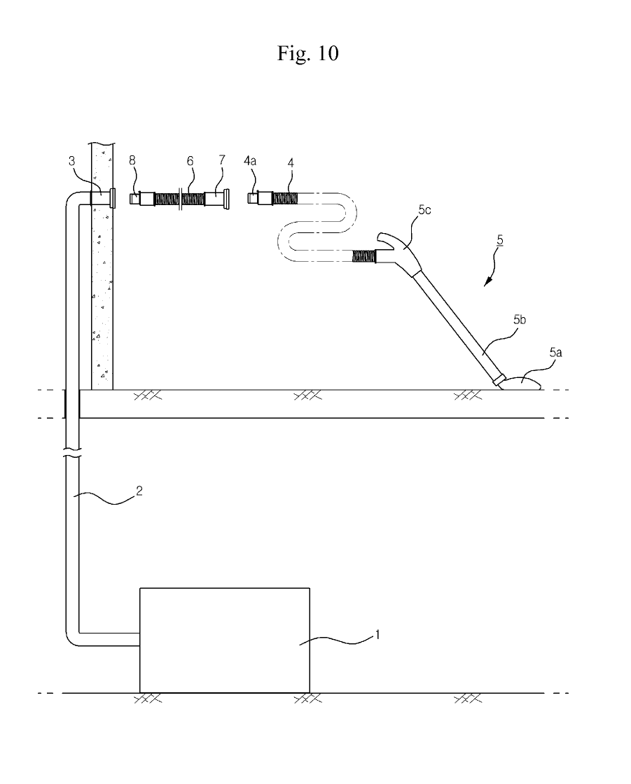

FIG. 10 is a view illustrating a use example of an extension hose for a vacuum cleaner according to the present invention.

Referring to FIG. 10, the extension hose 6 according to the present invention is fittingly engaged into the inlet valve 3 installed at the wall of a building so as to be connected to a suction pipe 2 extending from a central dust collector 1 installed at a part of the building to the building wall to form a vacuum line to extend the flexible hose 4 enabling a vacuum cleaning operation so that a vacuum cleaning work can performed conveniently even at a remote position. That is, the extension hose 6 according to the present invention is installed such that the electric wire 6a embedded in the extension hose 6 is connected to the female connector 7 and the male connector 8 respectively mounted at one end and the other end of the extension hose 6 to allow the female connector 7 and the male connector 8 to be electrically connected with each other so that the flexible hose 4 can be extended while being electrically connected with the extension hose 8.

As described above, the present invention has an effect in that the flexible hose for a vacuum cleaner can be extended to a desired length, thereby improving a convenience in use.

While the present invention has been described in connection with the exemplary embodiments illustrated in the drawings, they are merely illustrative embodiments, and the invention is not limited to these embodiments. It is to be understood that various equivalent modifications and variations of the embodiments can be made by a person having an ordinary skill in the art without departing from the spirit and scope of the present invention. Therefore, various embodiments of the present invention are merely for reference in defining the scope of the invention, and the true technical scope of the present invention should be defined by the technical spirit of the appended claims.

What is claimed is:

1. An extension hose for a vacuum cleaner, which is adapted to allow a flexible hose to be extended, the flexible hose having one end to which the vacuum cleaner including a brush nozzle is connected and the other end at which a male connector 4a is mounted so as to be fixedly fitted into an inlet valve installed at a wall of a building, the extension hose comprising;
a hose body configured to have the same structure as that of the flexible hose so that the flexible hose can be extended, the hose body including an electric wire embedded therein;
a female connector 7 mounted at one end of the hose body in such a fashion as to be electrically connected with the electric wire embedded in the hose body to cause the female connector to be electrically connected with the male connector 4a of the flexible hose, the female connector comprising a pair of ground terminals formed protrudingly on the inner circumferential surface thereof to have a predetermined tension through a ground spring so that the female connector is electrically contactingly connected with the male connector of the flexible hose; and
a male connector 8 mounted at the other end of the hose body in such a fashion as to be electrically connected with the electric wire embedded in the hose body so as to be fitted into the inlet valve, the male connector comprising a pair of ground pieces formed exposedly on the outer circumferential surface thereof, the ground pieces serving as contact points so that the male connector can be electrically connected with the inlet valve.

2. The extension hose for vacuum cleaners according to claim 1, further comprising a cover mounted at an opening formed at one end of the female connector 7 to allow the opening of the female connector to be opened or closed by an elastic restoring force of a spring 9a.
